(19) United States
(12) Patent Application Publication
(10) Pub. No.: US 2024/0330167 A1
(43) Pub. Date: Oct. 3, 2024

(54) Intelligent Process For Iterative Software Testing and Development

(71) Applicant: Tuyen Mathew Duong, San Jose, CA (US)

(72) Inventor: Tuyen Mathew Duong, San Jose, CA (US)

(21) Appl. No.: 18/620,230

(22) Filed: Mar. 28, 2024

Related U.S. Application Data
(60) Provisional application No. 63/455,204, filed on Mar. 28, 2023.

(51) Int. Cl. G06F 11/36; G06F 8/36; G06F 8/73; G06F 40/279

(52) U.S. Cl. CPC G06F 11/3688; G06F 8/36; G06F 8/73; G06F 11/3684; G06F 40/279

(57) ABSTRACT

Systems and methods provide an intelligent process for software testing and development. In one embodiment, the system: receives a user description of a test script, the description including one or more test cases defining specific tests to be executed; processes the user description using a description processing component, the description processing component configured to identify elements within the user description relevant to test script and test case generation, and generate a structured representation of the user description based on the identified elements; utilizes the structured representation to generate code for the test script; provides the user with an option to review and update the generated code and test cases; generates test data suitable for executing the generated test script; executes the generated test script and test cases using the test data; collects test results associated with the execution; and presents the test results to the user.

### CROSS-REFERENCE TO RELATED APPLICATION

This application claims the benefit of U.S. Provisional Patent Application Ser. No. 63/455,204, filed on Mar. 28, 2023, titled “An Agile Method To Solve Problems For Software Testing Development,” which is herein incorporated by reference in its entirety.

### TECHNICAL FIELD

Implementations relate generally to software testing and development. More specifically, implementations relate to methods and systems for providing an intelligent process for iterative software testing and development.

### BACKGROUND

The process of software development is inherently iterative and relies heavily on thorough testing to ensure the functionality, reliability, and quality of the final product. Traditionally, software testing involves manual creation of test scripts, which define the specific test cases to be executed. This manual approach can be time-consuming, error-prone, and difficult to maintain, especially for complex software systems with numerous test cases.

Existing automated testing frameworks partially address these challenges. Some frameworks allow users to define test cases using a specific programming language or scripting syntax. While offering some level of automation, these methods require programming expertise and can be cumbersome for those without coding experience. Other frameworks utilize visual tools for building test cases, but these tools often lack flexibility and can be limited in their ability to handle intricate testing scenarios.

While some recent advancements utilize natural language processing (hereinafter “NLP”) for test case generation, these often focus on specific aspects like code comments or user stories, and may not provide a comprehensive solution for generating entire test scripts from a user's high-level description. Additionally, existing source control management (hereinafter “SCM”) integration with testing tools can be complex and require manual intervention, hindering efficient version control of test scripts and associated results.

There is a need for a streamlined and user-friendly system that simplifies the generation of test scripts from natural language descriptions. This system should ideally be accessible to users with varying technical backgrounds, minimize the need for manual coding, and seamlessly integrate with existing source control practices. The present invention addresses these shortcomings by providing a method and system for generating code for software testing from user descriptions, offering an intuitive and efficient approach to test script creation and management.

### SUMMARY

The appended claims may serve as a summary of this application.

### BRIEF DESCRIPTION OF THE DRAWINGS

The present disclosure will become better understood from the detailed description and the drawings, wherein:

FIG. 1A is a diagram illustrating an exemplary environment in which some embodiments may operate.

FIG. 1B is a diagram illustrating an exemplary computer system that may execute instructions to perform some of the methods herein.

FIG. 2 is a flow chart illustrating an exemplary method that may be performed in some embodiments.

FIG. 3 is a diagram illustrating an iterative process for solving software testing problems, in accordance with some embodiments.

FIG. 4A is a diagram illustrating a workflow for creating code designed for software testing, in accordance with some embodiments.

FIG. 4B is a diagram illustrating an iterative process for software testing and presenting test results to a user, in accordance with some embodiments.

FIG. 5 is a diagram illustrating an integration of the system with a Source Control Management system, in accordance with some embodiments.

FIG. 6 is a diagram illustrating an exemplary computer that may perform processing in some embodiments.

### DETAILED DESCRIPTION

In this specification, reference is made in detail to specific embodiments of the disclosure.

For clarity in explanation, the disclosure has been provided with reference to specific embodiments, however it should be understood that the disclosure is not limited to the described embodiments. On the contrary, the disclosure covers alternatives, modifications, and equivalents as may be included within its scope as defined by any patent claims. The following embodiments of the disclosure are set forth without any loss of generality to, and without imposing limitations on, the disclosure. In the following description, specific details are set forth in order to provide a thorough understanding of the present disclosure. The present disclosure may be practiced without some or all of these specific details. In addition, well known features may not have been described in detail to avoid unnecessarily obscuring the disclosure.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

In software testing, test automation makes use of specialized tools to control the execution of tests instead of manual testing. It is a solution to provide the best practice for an Agile-based quality assurance process; however, some companies have been struggling to achieve that due to problems when implementing and working with test automation. The most common challenges often found in test automation development include complex or duplicated code development, lack of skilled automation resources, lack of quality control, and high cost of maintenance. The embodiments herein provide the benefit of reducing human error to improve quality and productivity at work. Human errors often occur in four types: unintended action or execution error (i.e., action-based slip), unintended memory error (i.e., memory-based lapse), intended rule-based mistake, or intended knowledge-based mistake.

The present embodiments seek to provide a solution to these problems by providing an iterative, Agile-based process that allows the user to solve problems for software testing development by describing the problem in pseudocode and allowing the system to dynamically generate programming code. There are multiple problems that the current embodiments can solve. One problem is core development. The present embodiments might mitigate the burdens of traditional core software test development by optimizing development work via a low-code or no-code platform. If the solution is available, individuals can reuse it. If a solution is unavailable, individuals can build the prototype and test it.

Another problem involves miscommunication. The present embodiments aim to solve miscommunication issues by reducing coding development tasks to a low-code or no-code environment. The system provides all necessary processes and utilities for individuals to iteratively solve the problem, test, control, maintain, and deliver. Individuals only need to learn or to understand basic guidelines of productivity work system applications to describe the problem. Miscommunications can be resolved by, e.g., reviewing procedure documents, pseudocode, and visual test results.

Another problem involves underestimating the task at hand. The present embodiments might improve the completion of development work by reducing the tasks involved to strategy-based problem-solution tasks. For example, the team might decide the best approach to complete the project is by dividing the team into multiple roles such as problem-solution preparer, problem-solution solver, problem-solution monitor and maintainer, problem-solution trainer, or problem-solution researcher. Players may then perform their roles without interruption. For example, preparers will prepare the relevant raw data provided from old or altered test results into prepared information. As a result, the preparation process should not have any interruption due to any dependencies of test resources or test equipment.

Another problem involves unrealistic or mismanaged timelines. The present embodiments might reduce mismanaged timelines because of a modularized design pseudocode base application. The initial draft solution from a problem-solution preparer and a problem-solution solver can provide the general high level work completion of a problem, where preparers are preparing raw data into prepared information data and solvers are producing the solution by preparing information data. The combination of preparer and solver should lead to the acquisition of enough information to provide the high-level complexity of a project, so that the team can resolve any problem with a possible solution. Any unrealistic problem-solution should be sent to a problem-solution strategist or researcher to decide the resolution. As a result, a team can optimize development timelines by identifying a workable problem-solution or an unworkable problem-solution.

Another problem involves feature creep or overload. The present embodiments might solve untested or duplicate work or solution because it provides an interface or resources for individuals to reuse a registered solution. Furthermore, the embodiments benefit from using a generic or general-purpose library to solve the problem.

Another problem involves quality. The present embodiments may improve the quality of work completion because of the low-code or no-code platform. The solution is created by describing the problem rather than by coding. The embodiments benefit from consistent reuse of a registered solution or use of a general-purpose library to improve the quality of the solution.

Another problem involves maintenance. The present embodiments should improve upon maintenance work due to integration with third-party tools to provide the necessary services to test, to control, to maintain, and to deliver.

Another problem involves documentation. The present embodiments solve the issue of documentation by use of pseudocode for explanation of the problem-solution. A visual prototype test result may also serve as a problem-solution verification.

In one embodiment, the system: receives a user description of a test script, the description including one or more test cases defining specific tests to be executed; processes the user description using a description processing component, the description processing component configured to identify elements within the user description relevant to test script and test case generation, and generate a structured representation of the user description based on the identified elements; utilizes the structured representation to generate code for the test script; provides the user with an option to review and update the generated code and test cases; generates test data suitable for executing the generated test script; executes the generated test script and test cases using the test data; collects test results associated with the execution; and presents the test results to the user.

Some embodiments may include an Agile-based method to solve problems for software testing development by employing a Productivity Work System Application or Describe-Get-System. Some embodiments may also include one or more of: a generic library, a regex utility, a template utility, a search verify utility, a robot framework, and a unreal device tool. Some embodiments may also include a third-party module including one or more of: a collaboration tool, a source control management tool, a project management tool, a continuous integration tool, a continuous delivery tool, and/or a defect tracking system. In some embodiments, the system employs an Agile method wherein a user can search existing or similar solutions of a current problem and reuse those solutions if they are available. In some embodiments, if no solution of a current problem is available, the method will generate a new solution.

Further areas of applicability of the present disclosure will become apparent from the remainder of the detailed description and the claims. The detailed description and specific examples are intended for illustration only and are not intended to limit the scope of the disclosure.

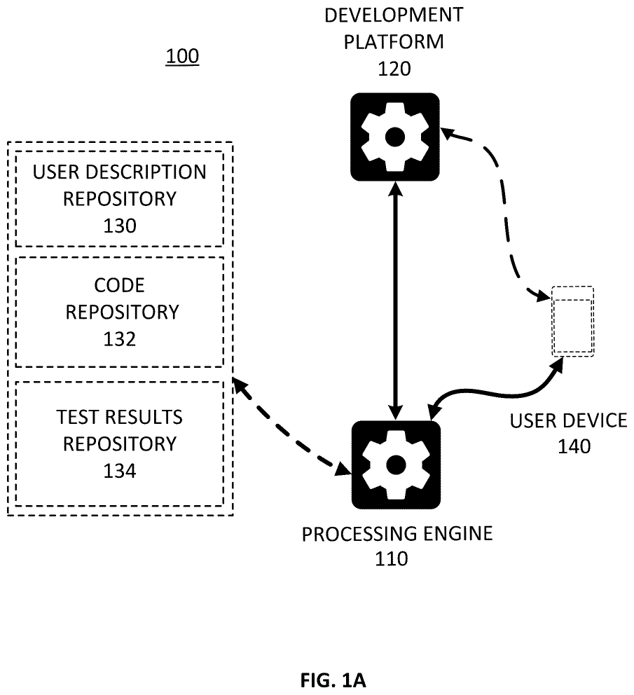

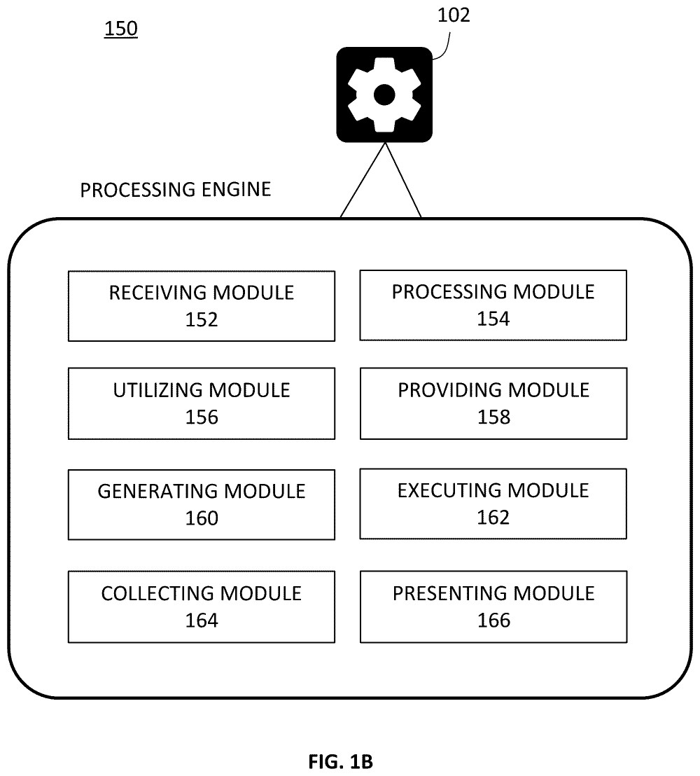

FIG. 1A is a diagram illustrating an exemplary environment in which some embodiments may operate. In the exemplary environment 100, a user device 140 is connected to a processing engine 110 and, optionally, a development platform 120. The processing engine 110 is connected to the development platform 120, and optionally connected to one or more repositories and/or databases, including, e.g., a user description repository 130, code repository 132, and/or a test results repository 134. One or more of the databases may be combined or split into multiple databases. The user device 140 in this environment may be a computer, and the development platform 120 and processing engine 110 may be applications or software hosted on a computer or multiple computers which are communicatively coupled via remote server or locally.

The exemplary environment 100 is illustrated with only one user device, one processing engine, and one development platform, though in practice there may be more or fewer additional user devices, processing engines, and/or development platforms. In some embodiments, the user device(s), processing engine, and/or development platform may be part of the same computer or device.

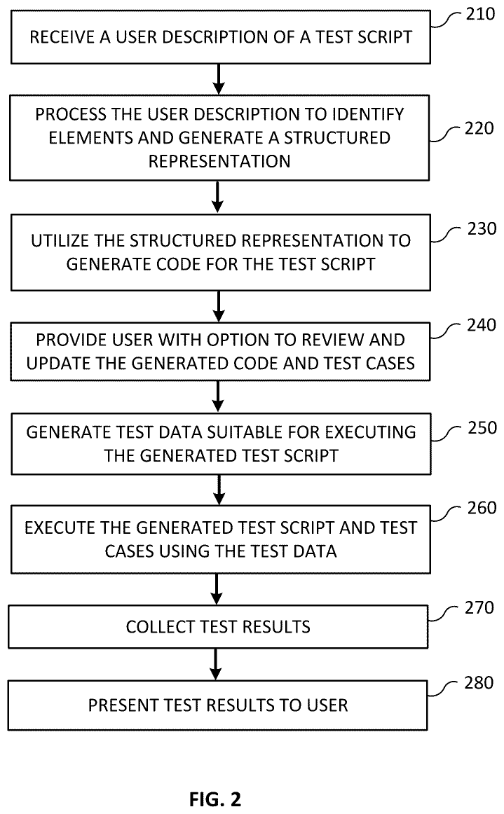

In an embodiment, the processing engine 110 may perform the exemplary method of FIG. 2 or other method herein and, as a result, provide an intelligent process for iterative software testing and development. In some embodiments, this may be accomplished via communication with the user device, processing engine, development platform, and/or other device(s) over a network between the device(s) and an application server or some other network server. In some embodiments, the processing engine 110 is an application, browser extension, or other piece of software hosted on a computer or similar device, or is itself a computer or similar device configured to host an application, browser extension, or other piece of software to perform some of the methods and embodiments herein.

The user device 140 is a device with a display configured to present information to a user of the device who is a user of the development platform 120. In some embodiments, the user device presents information in the form of a visual UI with multiple selectable UI elements or components. In some embodiments, the user device 140 is configured to send and receive signals and/or information to the processing engine 110 and/or development platform 120. In some embodiments, the user device is a computing device capable of hosting and executing one or more applications or other programs capable of sending and/or receiving information. In some embodiments, the user device may be a computer desktop or laptop, mobile phone, virtual assistant, virtual reality or augmented reality device, wearable, or any other suitable device capable of sending and receiving information. In some embodiments, the processing engine 110 and/or development platform 120 may be hosted in whole or in part as an application or web service executed on the user device 140. In some embodiments, one or more of the development platform 120, processing engine 110, and user device 140 may be the same device. In some embodiments, the user device 140 is associated with a first user account within a development platform, and one or more additional user device(s) may be associated with additional user account(s) within the development platform.

In some embodiments, optional repositories can include a user description repository 130, code repository 132, and/or test results repository 134. The optional repositories function to store and/or maintain, respectively, user descriptions submitted by a user of the development platform; code generated by the system as part of software testing; and test results generated by the system or third-party testing tools. The optional database(s) may also store and/or maintain any other suitable information for the processing engine 110 or development platform 120 to perform elements of the methods and systems herein. In some embodiments, the optional database(s) can be queried by one or more components of system 100 (e.g., by the processing engine 110), and specific stored data in the database(s) can be retrieved.

Development platform 120 is a platform configured to facilitate the testing and development of software in relation to the systems and methods herein. The development platform 120 may present a user with one or more user interfaces or interface components which facilitate the testing of software based on received user descriptions for test scripts.

FIG. 1B is a diagram illustrating an exemplary computer system 140 with software modules that may execute some of the functionality described herein. In some embodiments, the modules illustrated are components of the processing engine 110.

Receiving module 152 functions to receive a user description of a test script, the user description including one or more test cases defining specific tests to be executed.

Processing module 154 functions to process the user description using a description processing component configured to identify elements within the user description relevant to test script and test case generation, and generate a structured representation of the user description based on the identified elements.

Utilizing module 156 functions to utilize the structured representation to generate code for the test script.

Providing module 158 functions to provide the user with an option to review and update the generated code and test cases.

Generating module 160 functions to generate test data suitable for executing the generated test script.

Executing module 162 functions to execute the generated test script and test cases using the test data.

Collecting module 164 functions to collect test results associated with the execution.

Presenting module 166 functions to present the test results to the user.

The above modules and their functions will be described in further detail in relation to an exemplary method below.

FIG. 2 is a flow chart illustrating an exemplary method that may be performed in some embodiments.

At step 210, the system receives a user description of a test script. This user description defines the specific test cases that the system should generate code for and ultimately execute. A test script is a set of instructions that outlines the specific actions to be performed on a system and the expected outcomes for each action. It serves as a blueprint for automating the testing process. A basic example of a test script for login functionality may include: 1) start the application; 2) enter a valid username in the username field; 3) enter a valid password in the password field; 4) click the ‘login’ button; 5) verify that the system grants access to the application homepage; and 6) logout of the application. A test case represents a single unit of testing within a test script that focuses on verifying a specific aspect of a system's functionality. It defines a scenario where a particular set of actions are performed on the system, followed by a verification step to ensure the system behaves as expected. Examples of test cases for the above login functionality may include: verifying successful login with valid username and password; verifying an error message is received for an invalid username; and verifying system behavior for a locked account scenario.

In some embodiments, the system provides flexibility in the format of the user description, catering to users with varying technical backgrounds. In some embodiments, the user description can be provided in plain text format. The user can write a textual description of the desired test flow, outlining the steps involved in each test case. For example, a user might describe a test case for a login functionality by stating: “The user enters a valid username and password. The system verifies the credentials and grants access to the application.” In some other embodiments, the user description can be provided through voice commands. The system can integrate with a speech recognition module, allowing users to verbally describe the test cases. In some embodiments, the system allows users to select test cases from a graphical user interface (hereinafter “GUI”). The GUI can present pre-defined testing functionalities or allow users to build test cases by selecting options from, e.g., drop-down menus, checkboxes, or other interactive elements.

In some embodiments, the front-end for receiving user descriptions can be adapted based on the chosen format. For example, in the case of plain text input, an NLP module can be integrated to analyze the user's description and identify key elements related to test cases and their steps. Alternatively, for voice commands, a speech recognition module can be employed to convert spoken instructions into text, which can then be processed by the NLP module. In some embodiments, a GUI implementation might involve a combination of pre-defined testing functionalities represented by, for example, buttons or menus along with text fields for users to specify additional details for their test cases. In some embodiments, a modular approach allows the system to seamlessly adapt to different user input methods.

In some embodiments, the system identifies one or more inconsistencies within the user description, and prompts the user to address the inconsistencies before proceeding with code generation. In some embodiments, the system analyzes the user description for logical inconsistencies. This might involve checking for, e.g., contradictory statements, missing steps within a test case flow, or attempting to identify actions that might not be feasible within the system under test. In some embodiments, the system analyzes the user description for potential mismatches between data types. For instance, if a user describes entering a username but specifies a numerical value, the system might flag this as an inconsistency. In some embodiments, the system identifies phrases or descriptions that are ambiguous and could be interpreted in multiple ways. This might involve, for example, prompting the user for clarification to ensure the generated test script accurately reflects their intended testing goals.

Once inconsistencies are identified, the system can employ various methods to prompt the user for resolution. In some embodiments, the system can display clear and concise error messages highlighting the identified inconsistency within the user description. In some embodiments, the system offers interactive functionalities to assist the user in resolving inconsistencies. This could involve, for example, suggesting potential fixes, highlighting relevant sections of the description for review, or offering examples of how to rephrase the description to avoid ambiguity. In some embodiments, the system prevents code generation from proceeding until all identified inconsistencies are addressed by the user. This ensures the generated test script is based on a clear and unambiguous user description for optimal test script execution and test results.

At step 220, upon the user description being received, the system processes the user description using a description processing component. First, the system identifies elements within the user description that are relevant to test script and test case generation.

In some embodiments, the description processing component utilizes NLP techniques, particularly when dealing with plain text user descriptions. The NLP module can be trained on a dataset of testing-related keywords and phrases to identify elements relevant to test cases. In various embodiments, this may include, e.g., actions the user wants the system to perform (e.g., “login”, “search”), expected system responses (e.g., “displays error message”, “grants access”), or data values used during the test (e.g., “username”, “invalid password”).

In some embodiments, for user descriptions provided through voice commands, the system may integrate with a speech recognition module as a pre-processing step. This module converts the spoken instructions into text, which can then be fed into the NLP module for further analysis. Similar to plain text processing, the NLP module identifies key elements related to actions, responses, and data within the converted text.

In some embodiments, the description processing component can leverage pre-defined libraries or templates, particularly when the user description is provided through a GUI. These libraries or templates can contain commonly used testing functionalities represented as building blocks. When a user selects a specific functionality from the GUI (e.g., “login with valid credentials”), the description processing component can retrieve the corresponding pre-defined elements associated with that functionality. This streamlines the processing step for standardized testing procedures.

Next, the description processing component utilizes the identified elements to generate a structured representation. This structured representation refers to a formalized capture of the key elements extracted from the user's test script description. The structured representation acts as a bridge between the user's natural language description and the code that will ultimately be generated for the test script. This representation captures the elements identified during description processing, such as, for example, actions, expected responses, and data values, and potentially the sequence or relationships between them.

In some embodiments, the structured representation takes the form of a tree structure. The root of the tree represents the overall test script, with branches representing individual test cases. Each test case branch can further be subdivided into leaves, containing the identified elements like, e.g., actions, expected responses, and data values specific to that test case. This hierarchical structure serves to provide a clear and organized representation of the test logic. In some other embodiments, the system utilizes a flow chart as the structured representation. Flow charts visually depict the sequence of steps involved in the test script. Elements identified from the user description, such as actions and system responses, can be represented by flowchart symbols connected by arrows to indicate the flow of execution within each test case. In some other embodiments, the system employs a state machine diagram as the structured representation. State machines model the system's behavior under test by representing different states (e.g., login successful, login failed) and the transitions between them triggered by specific actions (e.g., entering credentials). By capturing these states and transitions based on the identified elements, the state machine diagram provides a structured representation that interacts with the system under test and verifies its behavior.

In various embodiments, the choice of specific structured representation format can be influenced by factors like the complexity of the test script and user preference. The invention offers flexibility by supporting multiple formats, allowing for efficient code generation regardless of the chosen representation. In some embodiments, the system translates the user's intent from the natural language description into a machine-readable format that can be processed for code generation in the following steps.

In some embodiments, the processing step further includes identifying dependencies between the test cases within the user description, and the utilizing step generates code that accounts for the identified dependencies when executing the test script. During the processing step, the system analyzes the user description to identify potential dependencies between the test cases. A dependency exists when the successful execution of one test case is a prerequisite for another test case to function correctly. The utilizing step then takes these identified dependencies into account. The generated code ensures that test cases are executed in the correct order, respecting any dependencies outlined within the user description. In some embodiments, identifying and handling dependencies involves the system analyzing the user description for keywords or phrases that might indicate dependencies between test cases. For instance, keywords like “after”, “following”, or “depending on” could signal a potential dependency. In some embodiments, the system might offer functionalities for users to explicitly define dependencies within the test case descriptions. This could involve options to specify which test case needs to be executed successfully before another one can be run. In some embodiments, the system can infer dependencies based on the implicit logic within the user description. For example, a test case verifying a successful login might be considered a dependency for another test case that involves adding items to a shopping cart while logged in.

At step 230, following the creation of a structured representation based on the identified elements, the system utilizes the structured representation to generate code for the test script. This code will ultimately be used to automate the execution of the test cases defined by the user. In this context, “code” refers to a set of instructions written in a programming language that can be understood and executed by a computer system. This code will automate the execution of the test cases defined by the user in their test script description.

In some embodiments, the code generation process may directly translate the elements within the structured representation into a specific programming language. For example, if the structured representation is a tree structure, the root node representing the test script might be translated into a function or class definition in the chosen language. Each child node representing a test case could be translated into a separate function call within the main script, with the specific actions, expected responses, and data values identified during processing forming the parameters or logic within each function.

In some embodiments, the system may import one or more existing libraries of pre-written code snippets for commonly used testing functionalities. When the structured representation identifies elements that align with functionalities within these libraries, the code generation module can integrate the relevant code snippets into the test script. This approach reduces code redundancy and leverages pre-tested code for efficient script generation. One example of existing libraries of pre-written code is unit testing frameworks. These libraries can provide pre-written functions for common testing tasks like, for example, asserting expected outcomes, setting up test data, and handling test fixtures. Such unit testing framework may include, e.g., JUnit (Java), PHPUnit (PHP), and pytest (Python). Another example involves the use of user interface (hereinafter “UI”) testing frameworks: These libraries offer functionalities for interacting with GUIs during testing. They may include pre-written code for finding elements on the screen, simulating user actions like clicks and typing, and verifying the visual state of the UI. Some examples include, e.g., Selenium (cross-language), Appium (mobile testing), and Robot Framework (various languages). The system may also make use of Application Programming Interface (hereinafter “API”) testing libraries, which provide tools for sending requests to APIs and validating the responses. They may include functionalities for building HTTP requests, parsing JSON responses, and asserting expected data within the responses. Examples include, e.g., RestAssured (Java), Requests (Python), and Postman (various languages). Yet another example of existing libraries includes database interaction libraries, which offer pre-written code for connecting to databases, executing queries, and manipulating data. This can be useful for setting up test data or verifying database interactions within the test cases. Examples include, e.g., JDBC (Java), SQLAlchemy (Python), and mongoose (JavaScript).

In some embodiments, the system presents a selection interface to the user. The selection interface is configured to allow the user to select relevant solutions from the library during code generation. In some embodiments, the system analyzes the elements within the structured representation and identifies functionalities that potentially align with pre-written code snippets or pre-defined functions within the library. The selection interface then dynamically displays a list of these suggested solutions relevant to the current element being processed during code generation. The user can review the suggestions and choose the most suitable option for their specific needs. For instance, if the structured representation identifies a “login” action, the interface might suggest pre-written code snippets for simulating user input in username and password fields or interacting with a login button.

In some additional or alternative embodiments, the interface can offer a search bar allowing users to actively search for functionalities within the library using keywords. This approach provides more flexibility for users who might have a specific testing need in mind that may not be directly suggested based on the structured representation analysis. Users can enter relevant keywords related to the desired functionality (e.g., “database connection”, “API request”), and the interface would display relevant code snippets or functions from the library that match the search criteria.

In some embodiments, the system incorporates an intermediate step of pseudocode generation. Pseudocode is a language resembling a general programming language syntax but independent of a specific platform or compiler. By first generating pseudocode based on the structured representation, the system can capture the overall test logic in a language-agnostic way. Subsequently, this pseudocode can be translated into a specific programming language chosen for the target testing environment. This two-step approach offers flexibility in code generation and allows for easier adaptation to different testing frameworks.

At step 240, the system provides the user with an option to review and update the generated code and test cases. In some embodiments, the system can present the generated code in a user-friendly format, highlighting the key elements extracted from the user description and their corresponding translation into code. This allows users to understand the logic behind the generated code and verify its alignment with their intended test cases. Code comments can also be integrated to explain specific sections of the code to further improve readability and maintainability.

In some embodiments, the UI offers functionality for reviewing and modifying the test cases themselves. For example, users may be able to edit the test script logic, test case parameters, or expected outcomes associated with each test case. Additionally, the interface might allow for inserting new test cases or deleting unnecessary ones, providing flexibility for refining the test script based on the user's review. The user may also be able to rearrange the order of existing test cases or modify specific actions within a test case to achieve the desired testing coverage. In some embodiments, this modification can be achieved by presenting the user with visual script editing within the UI, allowing users to, for example, drag and drop elements, add new steps, or modify existing steps. In some embodiments, the user interface displays the generated test cases along with their associated parameters. Users can then edit these parameters directly, replacing generic values with specific data relevant to their testing needs.

In some embodiments, the system allows a user with programming experience to directly edit the generated code. This can enable the user to fine-tune the generated code for specific needs or integrate custom functionalities. For example, a user may be testing a login functionality with various username and password combinations. The system generates code that automates login attempts and verifies expected responses (i.e., success or failure). However, the user wants to perform an additional step after a successful login, such as navigating to a specific page within the application. During code review, the user can leverage the editing capabilities to achieve this. For example, the user may identify the section of the generated code responsible for handling successful login. They can then insert their own code snippet within that section to navigate to the desired page after a successful login attempt. This custom code snippet could involve using existing libraries for interacting with web elements (e.g., Selenium) or utilizing the application's specific APIs for navigation. As another example, if the system provides pre-defined functions for common functionalities within the chosen programming language, the user might locate a function related to navigating to specific pages. They can then integrate a call to this function within the relevant section of the generated code, achieving the desired post-login action.

In some embodiments, the system is configured to perform source control management (SCM) on the generated code and test results. This includes preparing the generated code and test results for storage, and storing the prepared code and test results within a source control system. SCM refers to a system that tracks changes made to computer files and data over time. It allows users to revert to previous versions of files, collaborate on projects effectively, and maintain a historical record of changes. SCM systems provide a number of features, including: version control to assign version numbers to files, enabling users to track modifications and revert to earlier versions if necessary; collaboration features, whereby multiple users can work on the same files simultaneously, and whereby the SCM system facilitates merging changes and avoids conflicts between different versions; and traceability, whereby the SCM system helps users understand the evolution of files by tracking changes and who made them. Examples of SCM tools and systems include, e.g., Git, Subversion, and cloud-based solutions. These systems offer a central repository to store all versions of a file, allowing for efficient management and collaboration on various software development projects.

The implementation of SCM can be achieved through the system integrating with various software tools or services. In some embodiments, the system prepares the generated code and test results for efficient storage within the chosen SCM system. This preparation might involve, for example, bundling the code and test results together into a single archive or file format that facilitates easy retrieval and management within the SCM system. In some embodiments, the assign version numbers to the stored code and test results. In some embodiments, metadata about the generated code and test results can be incorporated. This might include, e.g., timestamps, user information, or specific test script descriptions.

In some embodiments, this preparation step includes the system adding comments to the generated code and test results. The process of adding comments can be implemented in various ways depending on the chosen SCM system and the specific functionalities offered by the system. In some embodiments, the system is configured to automatically insert comments within the generated code. These comments can provide insights into the origin and purpose of the code. For example, comments might reference the user description elements that led to the generation of specific code sections. Additionally, comments can be integrated within the test results to explain the rationale behind each test case and the expected outcomes. In some additional or alternative embodiments, the system can offer users an interface to review and add their own comments to both the code and test results before storing them within the SCM system. This allows users to provide additional context or explanations that might not be captured through automated commenting. Users can leverage their domain knowledge or testing expertise to document specific decisions made during the test script creation process.

In one example, a user describes a test script for a product search functionality within an e-commerce application. The system generates code to simulate entering a search query and verify the displayed results. During the preparation step for SCM, comments are added to both the code and test results. The comments within the code might explain that the specific search query was chosen based on user-specified filtering criteria in the description. Comments within the test results might document the expected behavior of the search results page, such as displaying relevant product categories or sorting results by price.

In some embodiments, after the preparation step, the system then interacts with the chosen SCM system to securely store the prepared code and test data. The SCM system maintains a central repository for storing all versions of the generated code and test results. This allows for version control, collaboration, and traceability.

In one example scenario, a user generates a test script for a login functionality. The system prepares the generated code and test results for storage. This involves creating a compressed archive file containing the code and a separate file summarizing the test results. The system then interacts with the chosen SCM system (e.g., Git) to securely store this archive and the test result file within a central repository.

In another example scenario, during the testing process, the user modifies the generated code to add an additional test case. The SCM system tracks this change, creating a new version of the code file. This allows the user to easily revert to the previous version if needed or compare the changes made across different versions.

At step 250, the system generates test data suitable for executing the generated test script. In some embodiments, the system incorporates a test data generation module that ensures the generated test script has the necessary data to execute the defined test cases.

In some embodiments, the test data generation module can leverage information extracted during user description processing. For example, when the user describes a test case, they might provide specific data values to be used during the test (e.g., username, password, and search query). The system can capture these data points and incorporate them into the generated test data set.

In some embodiments, the module can create additional test data based on pre-defined rules or patterns. For example, if a test case involves validating a login functionality with various username formats, the system can generate a set of usernames with different combinations of letters, numbers, and special characters, ensuring comprehensive testing of the input validation process.

In some embodiments, the system might integrate with external data sources to enrich the generated test data. For example, this could involve connecting to databases containing realistic customer information or product data to populate test cases requiring such details. By leveraging external data sources, the test data can more closely resemble real-world scenarios, potentially uncovering edge cases or data-related issues that might be missed with limited test data.

In some embodiments, the system may employ anonymization techniques. When the user description or external data sources contain sensitive or personally identifying information (e.g., real usernames, passwords), the system can anonymize this data during test data generation. This ensures data privacy is maintained while still providing the necessary data for test script execution.

At step 260, the system executes the generated test script and test cases using the test data. This execution serves to verify the functionality of the system under testing.

In some embodiments, the system leverages a dedicated test execution engine. This engine is responsible for interpreting the generated code, feeding it with the corresponding test data from the generated test data set, and running the test script. The execution engine then monitors the system under test for the expected responses or behaviors outlined within each test case.

In some embodiments, the user interface provides real-time feedback during test script execution. For example, this feedback might include the current test case being executed, the actions being performed on the system under test, and the received responses. Additionally, the user interface can display the results of each test case, indicating whether the expected outcome was achieved (i.e., pass) or if a deviation from the expected behavior was encountered (i.e., fail).

In some embodiments, the system can allow for parallel execution of test cases, especially for large test scripts, which can significantly reduce the overall testing time. In some embodiments, logging functionalities can be integrated to capture details of the test execution process, including, e.g., the actions performed, system responses, and any encountered errors. These logs can be valuable for debugging purposes and analyzing test results in more depth.

In some embodiments, upon completion of the test script execution, the system can generate a comprehensive test report. This report can summarize the overall test results, including, e.g., the number of passed and failed test cases, along with detailed information for each individual test case. The report may also incorporate logs or screenshots captured during execution in order to providing insights for developers or testers who need to investigate potential issues.

In some embodiments, the system is configured to interact with third-party testing tools for test execution. This allows the system to leverage the features and functionalities offered by existing testing frameworks for test script execution. This integration with third-party testing tools can be implemented in various ways depending on the specific third-party tools targeted for interaction. In some embodiments, one or more APIs allow programmatic access to the functionalities of the third-party tool. The system interacts with these APIs to send test scripts or test cases to the external tool for execution. The testing tool then handles the execution process, interacts with the system under testing, and returns the results back to the system through the same API. In some additional or alternative embodiments, the system makes use of an adapter design pattern to create a bridge between its internal data structures and the specific format or requirements of the chosen third-party testing tool. This approach involves developing an adapter module that translates the generated test script or test cases from the system's format into a format compatible with the external testing tool. The adapter then facilitates communication between the two systems, allowing the external tool to execute the test script and return the results.

At step 270, the system collects test results associated with the execution. In some embodiments, the system stores the test results within a dedicated test result repository. This captured data provides insights into the functionality of the system under test and allows for further analysis.

In some embodiments, the system collects a basic set of test results for each test case. This might include, for example, a simple pass/fail indicator, signifying whether the test case achieved the expected outcome. The system may additionally capture timestamps associated with each test case execution to provide a timeline for the testing process. Some embodiments can collect more detailed information. This could involve, for example, recording the actual responses received from the system under test during execution. For instance, if a test case validates a login functionality, the system might capture the response code or specific message displayed after the login attempt. This detailed data can allow for a more comprehensive analysis of potential deviations from expected behavior.

In some embodiments, the system highlights failed test cases within the test results. For example, the system can utilize visual cues such as different colors, bold text, or icons to clearly distinguish passed test cases from failed ones. In some embodiments, the presented UI can allow the user to filter specifically for failed test cases. In some embodiments, the system can present additional information for each failed test case. This might include, for example, the specific error message encountered, screenshots or logs captured during execution, or relevant code snippets associated with the failure.

In some embodiments, the system collects screenshots or screen recordings during test execution, particularly for test cases involving user interfaces. These visual representations can be used for debugging purposes. For example, they may be used to pinpoint the exact point where a test case failed and present, within the UI, a visual context for understanding the encountered issue.

In various embodiments, the collected test results can be stored in various formats depending on user preference and integration with existing tools. In some embodiments, the results might be saved as plain text files or log files in order to provide a simple and human-readable format for basic analysis. Alternatively, the system can integrate with existing test management tools, allowing a user to store and manage test results alongside other testing data within their preferred environment.

At step 280, the system presents the test results to the user. In some embodiments, the test results can be presented at a UI. The UI may be, in turn, accessed by the user via a user device, for example, a computer or mobile device such as a tablet or smartphone. This presentation may be performed in real-time upon the user submitting a description of a test script. In some embodiments, the test results may be accessed by the user via email or some other method of presentation.

In some embodiments, the system can present a comprehensive test report to the user. This report summarizes the overall test execution. This summary could include, for example, the total number of test cases executed, the number of passed and failed cases, and the overall test script execution time. In some additional embodiments, the report can provide detailed information for each individual test case. This might include one or more of, for example: a clear indication of pass/fail status; the specific test case description for easy reference; timestamps associated with test case execution; captured data relevant to the test case, such as actual system responses or error messages; and screenshots or screen recordings (if applicable) to visualize any encountered issues. The user interface can present this information in a user-friendly way, allowing for easy navigation and filtering of test results based on specific criteria (e.g., only failed tests).

In some embodiments, the system offers interactive visualizations of the test results. This could involve, for example, charts or graphs that visually represent the pass/fail distribution across test cases or highlight trends in execution times. Such visualizations can help users quickly grasp the overall testing outcome and identify areas requiring further investigation.

In some embodiments, the system allows users to export the test results in a data file within a structured data format (e.g., CSV or JSON). This format may be suitable for further analysis using external data analysis tools. In some embodiments, the system may provide further tools for integrating this data file with other data sets or using the data file to perform more advanced statistical analysis.

In some embodiments, the system can integrate with one or more communication tools to facilitate collaboration between testers and developers. In some embodiments, the system can automatically generate notifications (e.g., email, chat) for failed test cases, alerting developers of potential issues that require their attention. This can serve to streamline communication and expedites the debugging or fixing process.

In various embodiments, the system can provide various guidelines, strategies, or implementations which serve to reduce or mitigate human error, in order to improve the quality and productivity of software testing and development. Human errors often occur in four types: unintended action or execution error (i.e., action-based slip), unintended memory error (i.e., memory-based lapse), intended rule-based mistake, or intended knowledge-based mistake. In various embodiments, various processes for mitigating these human errors may be implemented.

Unintended actions or execution errors, or action-based slips, may be referred to as errors of action or errors of execution. They occur when an action performed is not what was intended. For example, a first developer may have an assignment to develop a number verification function which has one ‘num’ argument. That argument must be greater than zero and less than one million. A second developer has an assignment to develop the number verification function, which has two (num, k) arguments, where num must be greater than zero and less than 2 power of k. The first developer proposes a solution in code, but the actual committed code includes a typographical slip that omits a critical zero. The second developer proposes a solution, but the actual committed code includes a typographical slip that omits a ‘*’ symbol. These action-based slips can be mitigated by the system in various ways. In some embodiments, the system implements a fail-fast design to trigger compile-time or runtime errors when a typo is detected. In some embodiments, the system uses a function or method invocation over the operator.

Unintended memory errors, or memory-based lapses, occur when a user forgets to perform an action, typically due to distractions or the passage of time. In some embodiments, the system can mitigate such errors by making use of reusable general-purpose libraries. In some embodiments, the system assists or provides a user with a solution that the system determines the user is familiar with, so that the user does not need to recall or make assumptions about a development solution. For example, the system may assume a tester refers to using a Bash Wildcard matching pattern over Python regex matching because the test wants a simple matching pattern, and Python regex matching is too new to him or her. Furthermore, the tester can test and confirm the result using his or her own preferred tool. In some embodiments, the system provides an efficient and effective process or guideline to allow users or developers to backup and retrieve their work. For example, every submission to an SCM may be recorded as snapshots to develop smart backup and retrieval tools that can help to reduce memory-base lapse.

Intended rule-based mistakes occur due to misapplication of a good rule or application of a bad rule. In some embodiments, the system mitigates these mistakes by announcing or informing about any limitation or restriction when the current design cannot correct misapplication of a good rule or application of a bad rule. For example, the system may determine that a user has a plain text file and wants to create a configuration YAML file. The created config.yaml file did not write any comment data, because the YAML library does not support or preserve comment data during a yaml.dump operation. The author or creator of the create_config_yaml file must address or inform its limitation to clarify the intended rule-base mistake.

Knowledge-based mistakes occur when an individual has no rules or routines available to handle an unusual situation. For example, a software developer has an assignment to develop a function to modify, replace, or delete words in a line. After the developer ran a few tests and confirmed the results, the developer decided to close this assignment and mark the status as completed. Later on, a tester ran some tests and got unexpected results. The tester recorded errors and created a bug ticket for resolution. In some embodiments, the system attempts to simplify the complexity of the current design or implementation by applying modular design principles. In some embodiments, the system presents to the user explanations of modular design to help simplify solving problems, improve product maintenance, and maximize reusable resources at work. In some embodiments, the system may present one or more suggestions or corrections which reduce complexity via modular design principles. In some embodiments, the complexity reduction may depend on the total line of codes, while in other embodiments, the complexity reduction may depend on expectations, strategy, or available resources of the problem owner or user.

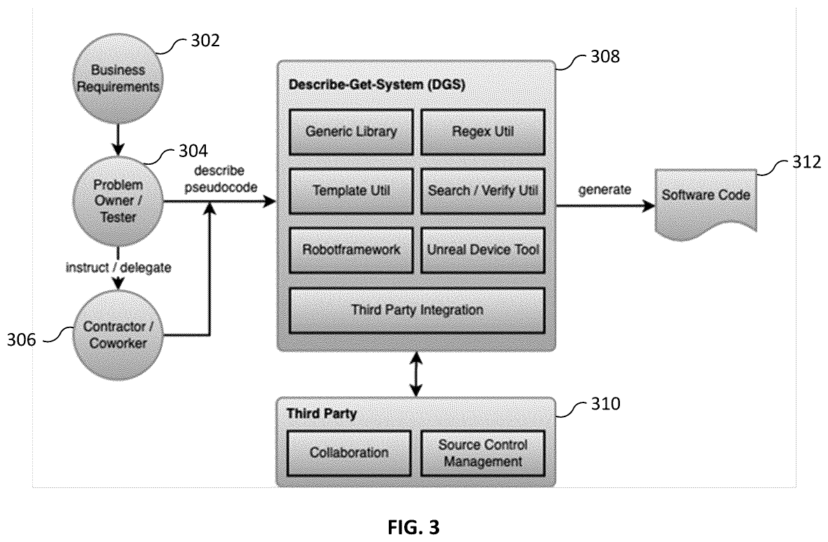

FIG. 3 is a diagram illustrating an iterative process for solving software testing problems, in accordance with some embodiments.

The system illustrated in the diagram represents an iterative process designed to automate and streamline software testing activities. This system incorporates functionalities to describe the desired test procedures, generate executable test scripts, and manage the overall testing process. An initial step involves a problem owner or tester 304 receiving a set of business requirements 302. This may serve as a set of business requirements for a piece of software, such as requirements captured by a company executive or a product lead. The problem owner or tester 304 uses these business requirements 302 to capture the software's functional requirements from the business stakeholders. The problem owner or tester 304 may represent the user interacting with the system. This person can be, for example, a software tester, a quality assurance (QA) specialist, or a developer tasked with creating automated test scripts. This user plays a role in providing the initial description of the desired test procedures.

The received business requirements may be documented by the problem owner or tester 304 in various ways, such as, for example, user stories, use cases, or acceptance criteria. In some embodiments, the problem owner or tester 304 instructs or delegates to one or more contractors or coworkers the software's functional requirements. Either the problem owner or tester 304, the one or more contractors or coworkers, or a combination thereof describes the software's functional requirements in pseudocode, which is submitted as a user description to the system, which is labeled as the Describe-Get-System (DGS) 308 within the diagram. The DGS 308 may also be referred to as a Productivity Work System Application.

The DGS 308 receives and analyzes the pseudocode or user description submitted by the problem owner or tester 304 or the one or more contractors or coworkers 306. The DGS 308 may contain a number of modules, including a generic library, regular expression utilities (“regex util”), template utilities (“template util”), search and verify utilities (“search verify util”), a robot framework, an unreal device tool, and one or more third-party integrations.

The generic library represents a repository of reusable software components that the DGS can leverage during test script generation. These components might encompass, e.g., common testing functionalities, user interface interaction methods, or data manipulation routines.

The regular expression utility includes helper functions or modules that assist the DGS in various tasks related to test script creation. Examples might include, e.g., functions for string manipulation or data parsing.

The template utility functions to facilitate the automated generation of test scripts. It can serve as a bridge between the user's natural language description of the desired test procedures and the actual executable code that drives the testing process. In some embodiments, the template utility may utilize pattern matching techniques to analyze the user's description within the DGS interface. It can identify keywords, phrases, or specific verb conjugations that indicate desired testing actions. For instance, the system might recognize phrases like “login with username” or “verify the displayed product details” and map these to corresponding pre-defined templates within its library. In some embodiments, the template utility maintains a library of pre-built code snippets or templates corresponding to common testing actions. These templates can encompass functionalities such as, for example, user interface interactions (e.g., entering text, clicking buttons), data manipulation routines (e.g., generating random test data), or assertion statements (e.g., verifying expected outcomes). In some embodiments, when the template utility identifies a match between the user's description and a template within the library, it populates the template with specific details extracted from the user's input. This might involve filling placeholders within the template with relevant data values, such as usernames, passwords, or expected product names. Through the process of pattern matching, template selection, and population, the template utility assembles the building blocks for the final test script. It translates the user's natural language description into a structured, executable code format that can be used to automate the testing process.

The search and verify utility allow the DGS to interact with the software under testing and locate specific elements or data points based on the instructions within the test script. Once the search utility locates the desired element, the system verifies by comparing the actual state or value found within the software under testing against the expected outcome specified in the test script. This search and verify utility works hand-in-hand with the code generation functionalities within the DGS. In some embodiments, the generated test script translates the user's description of desired actions into code that utilizes the search and verify functionality to interact with the software under testing and confirm expected outcomes.

The robot framework optionally represents an external testing framework that the system can potentially integrate with. It provides a structured format for creating test cases using keywords and libraries. The unreal device tool represents a set of utilities and tools which can be used for preparing precondition and postcondition test data for dry run execution. In some embodiments, user-provided test data is fed as input into the unreal device tool, and this test data is modelized for use in a unit test script.

Third-party integration represents the system's ability to interact with external tools or functionalities. This might involve integrating with third-party tools 310, which may take the form of, e.g., bug tracking systems, version control systems, or other testing frameworks to enhance the overall testing process. Within these third-party tools 310, the collaboration module signifies functionalities that enable multiple users to work on the same test scripts simultaneously. This might involve features for, e.g., shared access, version control, and conflict resolution. The Source control management module refers to the system's capability to track changes made to test scripts over time. This allows users to revert to previous versions if necessary and maintain a historical record of modifications.

In some embodiments, third-party project management tools may be additionally included which can serve to facilitate task management, collaboration and integration with Agile testing processes. In some embodiments, third-party tools may be additionally included which provide continuous integration and/or continuous delivery (“CI/CD”). These tools can streamline the software development lifecycle by automating various stages of the process. For continuous integration (“CI”), third-party tools can integrate code changes from multiple developers, automatically build and test the codebase, and identify potential issues early in the development cycle. For continuous delivery (“CD”), these tools can automate the deployment process, allowing for frequent and reliable releases of the software. By integrating seamlessly with the agile testing process, such third-party CI/CD tools can enable faster feedback loops, improved software quality, and more efficient deployments.

In some embodiments, a third-party defect tracking system may be additionally included which provides functionalities to manage, report, and track software defects throughout the development lifecycle. This integration can significantly enhance the agile testing process. The defect tracking system allows testers to efficiently log and categorize identified issues. It facilitates communication and collaboration between testers, developers, and other stakeholders by providing a centralized platform for defect reporting, assignment, and resolution tracking. In some embodiments, the system can additionally provide features for prioritizing defects based on severity, assigning deadlines for resolution, and generating reports to analyze trends and identify areas for improvement in the software development process.

The Agile-based testing process depicted in the diagram leverages the DGS 308 as a processing engine. Users describe their desired test procedures through the DGS interface. The DGS analyzes this description, utilizes the generic library and regular utilities, and potentially integrates with external testing frameworks to generate software code 312 representing executable test scripts. These scripts, once generated, can then be stored within a source control management system and potentially collaboratively edited by different users.

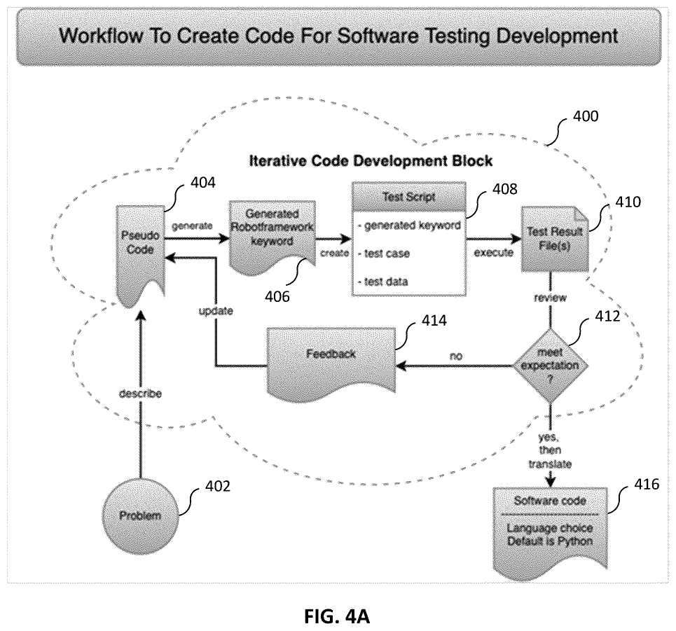

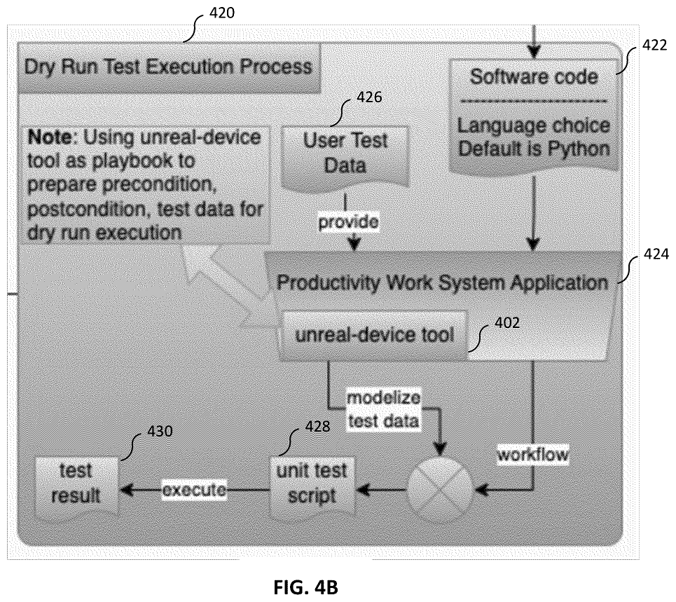

FIG. 4A is a diagram illustrating a workflow for creating code designed for software testing, in accordance with some embodiments.

An Iterative Code Development Block 400 represents an iterative development process where test script code is continually refined based on user input or test results. Input to this Iterative Code Development Block 400 includes a problem 402 or a sub-problem of the problem 402 that the user is attempting to solve. In some embodiments, prior to any engagement with iterative testing or development processes, a search is performed to determine whether an existing solution can be retrieved for the problem. In some embodiments, this search is automated and involves targeted search of one or more solution repositories. In some embodiments, the search is semi-automated or conducted manually by the user through a user interface containing such components as a search field or other text field for submitting the problem or sub-problem. If an existing solution is retrieved, then the system may reuse or modify this solution as necessary. The remaining steps of FIG. 4A can be skipped, and the system may enable the existing solution to be incorporated into a product to be deployed. In some embodiments, some degree of testing or iteration is performed on the existing solution to ensure it solves the problem or sub-problem effectively. If the search retrieves no existing solution, then the iterative process of FIG. 4A continues with description of the problem 402.

In some embodiments, this problem 402 is described in the language of pseudocode 404. This pseudocode 404 refers to a preliminary stage where the user creates a draft or outline of the test script logic using a more human-readable format. This pseudo code might involve keywords, phrases, or comments describing the desired test steps. The system receives this pseudocode 404 and uses it to generate a robot framework keyword 406. The robot framework keyword 406 represents an optional integration with the Robot Framework, an open-source framework for creating automated test scripts. If used, the generated test script might leverage keywords and libraries provided by the Robot Framework. This keyword is then used to generate a test script 408. This test script is an executable test script designed to automate software testing procedures. The specific format of the test script depends on the chosen tools or integrations used to generate it. The test script 408 can include a generated keyword, one or more test cases, and test data used by the test script during execution. This test data might include, e.g., usernames, passwords, product search queries, or any other values required to simulate various testing scenarios.

The test script 408 is then executed to generate one or more test result files 410. The test script interacts with the software under testing to simulate user actions and verify expected behaviors. The user then has the option to review the test result files, which may include the generated test script and test results. The system determines from the user, via a user interface, whether the user's expectations have been met (decision point 412). If the user expresses that their needs have not been met, the user is invited to submit feedback or modify the test script in some way. For example, the user might modify the test script logic (potentially by refining the pseudo code), adjust test data, or update the test cases based on the execution outcome. The user may express these modifications or updates in pseudocode 404, thus resulting in an iterative feedback loop for the system. Based on user review and test results, the initial description in the pseudo code can be refined to enhance the effectiveness of the generated test script in subsequent iterations. If the user communicates that their needs have been met, then the system translates the test script into software code 416 and presents it to the user. The user may be able to have the system generate code in a language of the user's choice, such as Python.

The workflow depicted in the image emphasizes an iterative approach to test script development. Users initially outline their desired test procedures in a human-readable pseudo code format. The system then translates this pseudo code into an executable test script, potentially leveraging frameworks like Robot Framework. This test script is executed, and the results are used to inform further refinement of the test script logic or test data through the review and update stage. This iterative process allows for ongoing improvement and ensures the generated test script accurately reflects the intended testing goals.

FIG. 4B is a diagram illustrating an iterative process for software testing and presenting test results to a user, in accordance with some embodiments. FIG. 4B serves as a continuation of the diagram in FIG. 4A. Software code 422 is the code generated as an end result of the process shown in FIG. 4A, where a test script is translated into software code.

The diagram depicts a dry run test execution process 420, which represents a stage where the system performs a preliminary execution of the software code for the test script with user test data. The software code is received as input by the Productivity Work System Application 424, which is elsewhere referred to as the Describe-Get-System (DGS). Within this system, an unreal-device tool 402 serves to prepare precondition and postcondition test data for dry run execution. This tool receives user-provided test data that supplements the core test procedures within the user description. Preconditions specify steps to be performed before test execution (e.g., setting up test data), while postconditions outline actions to take after test execution (e.g., cleaning up test data). Test data refers to the specific values the script will use during execution (e.g., usernames, passwords, or product search queries). The user can provide this supplemental test data through an interface provided by the system. The system is modelized the test data by incorporating these preconditions, postconditions, and test data provided by the user. The DGS outputs a test workflow for the test data, and both the test workflow and the modelized test data are incorporated into a unit test script 428. The unit test script is executed to obtain a test result 430 or potentially multiple test results 430.

In some embodiments, upon the test result(s) being received, the system may again determine where the test results meet user expectations. If no, then the process may return to the iterative prototype development block in order to improve the pseudocode and ensuing test script. If yes, then in some embodiments, the system may send the software code to be committed within one or more repositories of a Source Control Management system. In some embodiments, the system may then enable one or more automated or semi-automated systems for deployment and delivery of the tested software code, or the user may perform one or more manual steps to effectuate deployment and delivery, or one or ore third-party integrated tools may effectuate automated or semi-automated deployment or delivery. In some embodiments, the final product may then be shipped by the user, with or without use of first-party or third-party tools for doing so.

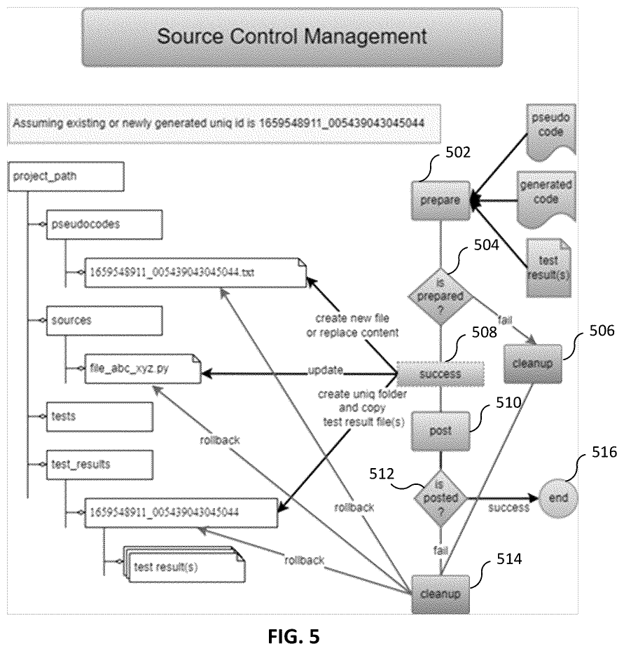

FIG. 5 is a diagram illustrating an integration of the system with a Source Control Management (“SCM”) system or version control system, such as, e.g., Git. The diagram illustrates the steps involved in managing source code using such a system. Version control systems allow for tracking changes made to code over time, facilitating collaboration, and enabling reverting to previous versions if necessary. On the left of the diagram, an example of a version control file directory is presented. In an initial state, a unique identifier (“unique ID”) is assigned to a unit of source code. This unique ID could be, e.g., a filename, a revision number, or an identifier generated by the version control system itself.

First, at the prepare step 502, the system may create a new file or retrieve a specific version of an existing file from the version control system based on one or more received inputs, including, for example, pseudocode, generated code, or one or more test results. The system determines if committing these changes to the repository has been successful (decision point 504). If this preparation has failed, the system performs a cleanup step 506. This may represent any task that may be necessary for preparation to succeed, such as, e.g., cleaning up files or notifying one or more developers of the unsuccessful commit. If the system is successful (outcome 508) in committing changes to the version control system, the system proceeds with, e.g., creating a new file or replacing content for an existing file; updating a file; or creating a unique folder and copying test result files, depending on the changes being committed. The system will then post an update 510. This typically involves specifying a descriptive message summarizing the modifications and storing this new version within the version control system. The system determines if the update has been posted successfully (decision point 512). If yes, then the flowchart ends 516, indicating the successful completion of a source code modification and update process within the version control system. If the post has failed, then the system performs a cleanup step 514, which may include one or more optional rollbacks of committed changes. This represents the possibility of reverting to a previous version of the code, which may be necessary if errors are detected or if a different code version is preferred.

Overall, the flowchart depicts a streamlined workflow for managing source code using a version control system. It highlights the key stages of creating or modifying code, committing changes with descriptive messages, and the option to revert to previous versions if necessary.

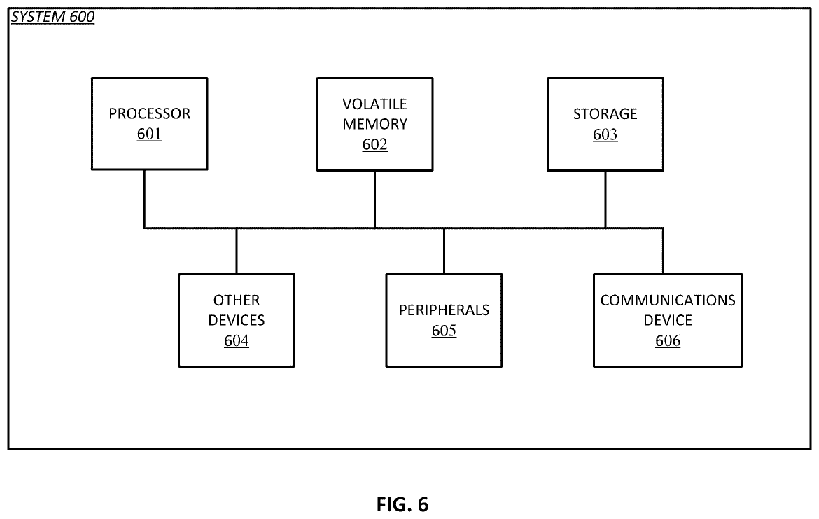

FIG. 6 is a diagram illustrating an exemplary computer that may perform processing in some embodiments. Exemplary computer 600 may perform operations consistent with some embodiments. The architecture of computer 600 is exemplary. Computers can be implemented in a variety of other ways. A wide variety of computers can be used in accordance with the embodiments herein.

Processor 601 may perform computing functions such as running computer programs. The volatile memory 602 may provide temporary storage of data for the processor 601. RAM is one kind of volatile memory. Volatile memory typically requires power to maintain its stored information. Storage 603 provides computer storage for data, instructions, and/or arbitrary information. Non-volatile memory, which can preserve data even when not powered and including disks and flash memory, is an example of storage. Storage 603 may be organized as a file system, database, or in other ways. Data, instructions, and information may be loaded from storage 603 into volatile memory 602 for processing by the processor 601.

The computer 600 may include peripherals 605. Peripherals 605 may include input peripherals such as a keyboard, mouse, trackball, video camera, microphone, and other input devices. Peripherals 605 may also include output devices such as a display. Peripherals 605 may include removable media devices such as CD-R and DVD-R recorders/players. Communications device 606 may connect the computer 100 to an external medium. For example, communications device 606 may take the form of a network adapter that provides communications to a network. A computer 600 may also include a variety of other devices 604. The various components of the computer 600 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure is, accordingly, to be regarded in an illustrative sense rather than a restrictive sense.

What is claimed is:

1. A method comprising:
receiving a user description of a test script, the user description comprising one or more test cases defining specific tests to be executed;
processing the user description using a description processing component configured to:
identify elements within the user description relevant to test script and test case generation, and
generate a structured representation of the user description based on the identified elements;
utilizing the structured representation to generate code for the test script;
providing the user with an option to review and update the generated code and test cases;
generating test data suitable for executing the generated test script;
executing the generated test script and test cases using the test data;
collecting test results associated with the execution; and
presenting the test results to the user.

2. The method of claim 1, wherein the code generation step comprises leveraging a library of existing solutions for commonly used testing functionalities.

3. The method of claim 2, wherein the library of existing solutions comprises solutions pre-configured for specific testing functionalities.

4. The method of claim 2, further comprising a selection interface configured to allow the user to select relevant solutions from the library during code generation.

5. The method of claim 1, wherein the code generation step comprises employing pseudocode generation as an intermediate step.

6. The method of claim 1, further comprising:
performing source control management on the generated code and test results, the source control management comprising:
preparing the generated code and test results for storage, and
storing the prepared code and test results within a source control system.

7. The method of claim 6, wherein the preparing step for source control management comprises adding comments to the generated code and test results.

8. The method of claim 1, wherein the user description is provided in a format selected from the group consisting of plain text, voice commands, and a graphical user interface selection.

9. The method of claim 1, wherein the description processing component further comprises a natural language processing module configured to identify the elements within the user description.

10. The method of claim 9, wherein the natural language processing module is further configured to identify keywords and phrases associated with testing concepts.

11. A system comprising:
one or more processors; and
memory storing instructions that, when executed by the one or more processors, cause the system to perform operations comprising:
receiving a user description of a test script, the user description comprising one or more test cases defining specific tests to be executed;
processing the user description using a description processing component configured to:
identify elements within the user description relevant to test script and test case generation, and
generate a structured representation of the user description based on the identified elements;
utilizing the structured representation to generate code for the test script;
providing the user with an option to review and update the generated code and test cases;
generating test data suitable for executing the generated test script;
executing the generated test script and test cases using the test data;
collecting test results associated with the execution; and
presenting the test results to the user.

12. The system of claim 11, wherein the structured representation comprises a format selected from the group consisting of a tree structure, a flow chart, and a state machine diagram.

13. The system of claim 11, further comprising an integration module configured to interact with third-party testing tools for test execution.

14. The system of claim 11, wherein the user review and update step allows the user to modify the test script logic and test case parameters.

15. The system of claim 11, wherein the presenting step comprises highlighting failed test cases within the test results.

16. The system of claim 11, wherein the structured representation is generated in a machine-readable format.

17. The system of claim 11, wherein the processing step further comprises identifying dependencies between the test cases within the user description, and the utilizing step generates code that accounts for the identified dependencies when executing the test script.

18. The system of claim 11, wherein the one or more processors cause the system to perform further operations comprising:
Identifying one or more inconsistencies within the user description, and
prompting the user to address the inconsistencies before proceeding with code generation.

19. The system of claim 11, wherein the presenting step provides the user with an interface to export the test results in a format selected from the group consisting of a report document, a graphical chart, and a data file suitable for further analysis.

20. A non-transitory computer-readable medium containing instructions comprising:
receiving a user description of a test script, the user description comprising one or more test cases defining specific tests to be executed;
processing the user description using a description processing component configured to:
identify elements within the user description relevant to test script and test case generation, and
generate a structured representation of the user description based on the identified elements;
utilizing the structured representation to generate code for the test script;
providing the user with an option to review and update the generated code and test cases;
generating test data suitable for executing the generated test script;
executing the generated test script and test cases using the test data;
collecting test results associated with the execution; and
presenting the test results to the user.
